(19) United States
(12) Patent Application Publication
(10) Pub. No.: US 2010/0080574 A1
(43) Pub. Date: Apr. 1, 2010

(54) PRINTING DEVICE WITH SENSOR FOR OUTPUT TRAY

(75) Inventor: Keiko Torikoshi, San Mateo, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 12/240,896

(22) Filed: Sep. 29, 2008

(51) Int. Cl. G03G 15/00

(52) U.S. Cl. 399/19

(57) ABSTRACT

To solve the problem of incorrect jam recovery, a printer is equipped with one or more sensors to detect the number of sheets outputted to the output tray(s) of the printer. The number of sheets outputted to the tray(s) for a print job is counted, and compared to the number of pages to be printed in the print job. If the numbers do not match, the printer notifies the user of the mismatch. The user may then inspect the printed sheets to determine whether some pages are missing or extra pages have been printed, and take appropriate corrective actions.

### BACKGROUND OF THE INVENTION

1. Field of the Invention

This invention relates to a printing device, and in particular, it relates to a printing device with a sensor for the output tray.

2. Description of Related Art

In conventional printers, when a paper jam or other printing error occurs, the printer notifies the user of the error, and resumes printing after the user clears the jam or other error. The printer typically re-prints the page or pages that were not properly printed due to the error. However, sometimes the printer may not correctly re-print the pages, and as a result, some pages may not be printed, or extra pages may be printed.

### SUMMARY

Accordingly, the present invention is directed to a printing device and related method that substantially obviates one or more of the problems due to limitations and disadvantages of the related art.

An object of the present invention is to provide a convenient way to warn a user when incorrect jam recovery occures.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a printing device which includes: a print engine for forming images on sheets of recording media; an output device for receiving sheets outputted from the print engine; an I/O section for receiving a print job; a control section; and a sensor device associated with the output device and connected to the control section, the sensor device detecting sheets outputted from the print engine to the output device, wherein the control section obtains a number of sheets to be printed for a print job, obtains from the sensor device a number of sheets actually outputted to the output device for the print job, and compares the number of sheets to be printed and the number of sheets actually outputted.

In another aspect, the present invention provides a printing method implemented in a printer, which includes: (a) receiving a print job; (b) obtaining a number of sheets to be printed for the print job; (c) generating a plurality of printed sheets based on the print job and outputting them to an output device of the printer; (d) detecting a number of sheets actually outputted to the output device for the print job; and (e) comparing the number of sheets to be printed and the number of sheets actually outputted to the output device.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic block diagram of a system including a printing device according to an embodiment of the present invention.

FIG. 2 illustrates a printing method according to an embodiment of the present invention.

### DETAILED DESCRIPTION OF PREFERRED EMBODIMENTS

To solve the problem of incorrect jam recovery, a printer is equipped with one or more sensors to detect the number of sheets (recording media) outputted to the output tray of the printer. The number of sheets outputted to the tray for a print job is counted, and compared to the number of pages to be printed in the print job. The number of pages for a print job is obtained from the device (e.g. a computer) that submitted the print job, or from the print data itself. If the number of sheets detected by the sensor does not agree with the number of pages in the print job, the printer notifies the user of the mismatch. The user may then inspect the printed sheets to determine whether some pages are missing or extra pages have been printed, and take appropriate corrective actions such as re-printing the missing pages or discarding the extra pages.

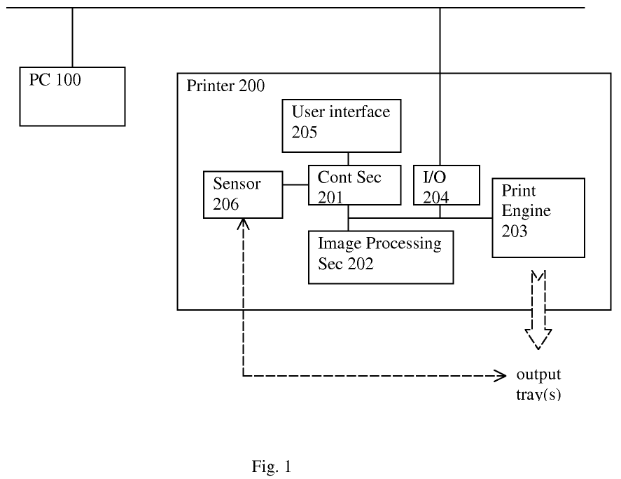

FIG. 1 is a schematic block diagram showing an exemplary printing system. The printing system includes a personal computer (PC) 100 and a printer 200 connected through a data communication line, such as a serial bus, a local area network (LAN), a wide area network (WAN), and so on. The PC 100 has a structure commonly known in which a document to be printed is created using an application program, and upon a user's instruction, the document is sent to the printer 200 in a form of PDL (page description language) data or other appropriate data.

The printer 200 includes a control section 201, an image processing section 202, a print engine 203, an input/output (I/O) section 204, a user interface section 205, and one or more sensors 206. The control section 201 includes a central processing unit (CPU), a random access memory (RAM), and a read only memory (ROM). The CPU reads out various software programs stored in the ROM into the RAM to control the internal sections 202 through 206 of the printer 200. The image processing section 202 carries out various image processing under the control of the CPU 201, and sends the processed image data to the print engine 203. The print engine 203, which for instance employs the electrophotographic process, forms an image on a recording sheet based on the image data sent from the image processing section 202. The I/O section accepts print data from PC 100. The user interface section 205 includes various input keys and/or display devices such as indicator lights or a display panel.

According to embodiments of the present invention, one or more sensors 206 are provided in the printer 200 to detect the number of sheets outputted to the output tray. The sensor may be physically located near where printed sheets exit the sheet transport mechanism of the print engine, or at other locations of the output tray. The sensor may be an optical sensor, an electrical sensor, a mechanical sensor, or any other suitable types of sensors, or a combination thereof. Preferably, the sensor 206 detects completely outputted sheets; sheets that are partially outputted to the tray due to an error are not counted. In one example, the sensor is located at the exit of the sheet transport mechanism and checks whether each sheet passed through completely or not. In another example, the sensor has the ability to measure the paper length which passes through the sensor, and compare it to the paper length of the print job. For example, the paper length should be 8.5 inches if the print job specifies letter sized paper in portrait orientation, or 11 inches if the print job specifies letter sized paper in landscape orientation. The sensor receives signals from the control section 201 indicating the start and end of a print job, detects and counts the number of outputted sheets for the print job, and sends the result to the control section 201. The sensor 206 includes appropriate circuitry to perform the counting functions.

The total number of pages to be printed in a print job is obtained from the print job itself. In some cases, the print job received from the computer includes commands or a job ticket that accompanies the file to be printed. The commands or job ticket specifies various printing requirements including the number of copies to be printed and (if appropriate) the page range of the file to be printed. In such a case, the printer 200 obtains the total number of pages using the information contained in the command or the job ticket. In some other cases, the printer 200 receives from the computer 100 print data (e.g. PDL data) for the print job without a command or job ticket containing the requisite information. In such a case, the printer 100 obtains the total number of pages by examining the print data. Further, a print job may request printing multiple copies of the document, or printing selected pages of the document. In such instances, the total number of pages of the print job is calculated from the number of copies and/or the page range.

After printing is finished, the control section 201 compares the total number of pages to be printed (obtained from the job ticket or the print data) with the total number of pages actually printed (detected by the sensor). If the numbers do not match, the printer generates a warning signal indicating such a mismatch. The warning signal may take a variety of forms. For example, it may be a simple warning light, located on the printer's control panel or near the sensor or at other suitable locations on the printer, that will be lit when a mismatch occurs. Another example is an audible signal such as a beep. Another example is a message displayed on a display (e.g. an LCD screen) on the control panel of the printer. Another example is a message displayed on the monitor of the computer 100 that submitted the print job (i.e. the printer sends a message to the computer). The warning signal may also be a combination of the above or any other suitable form of signals.

The printer 200 may include multiple output trays, collectively referred to as the output device. Each tray may be equipped with one or more sensors, collectively referred to as the sensor device. A print job may output to more than one tray, in which case the total number of outputted sheets for the print job is the sum of detected output sheets in all trays. Further, the print command or job ticket may specify which output trays are to be used for the print job and how many pages are to be outputted to each tray. For example, the job ticket may specify that the document contains twenty pages, and that three copies of the document are to be printed and each copy is to be outputted to a separate output tray. If each output tray is equipped with a sensor, the sensor device detects and counts the number of sheets outputted to each tray. The control section 201 may compare the actual number of sheets outputted to each tray with the number of sheets to be outputted to each tray as specified in the jot ticket, and generate a warning signal if one or more mismatches in the numbers are found. For example, a warning light associated with the output tray that has a mismatch may be lit.

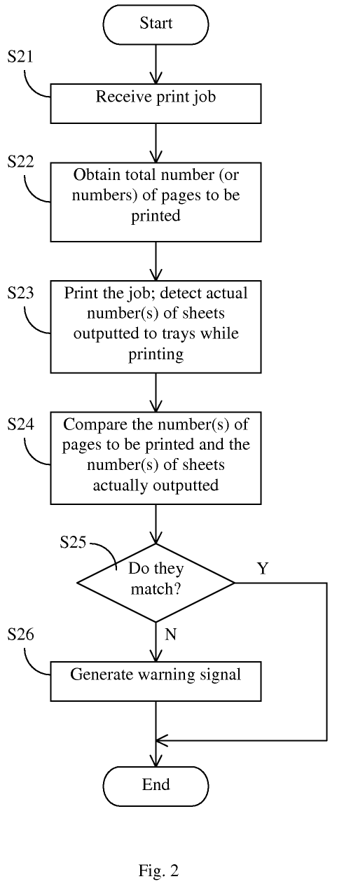

FIG. 2 is a flow diagram illustrating a printing method performed by a printer according to an embodiment of the present invention. First, the printer receives a print job to be printed from the computer (step S21). The printer obtains the total number of pages to be printed for the print job, including the number to be outputted to each output tray if specified (step S22). As mentioned earlier, the number may be specified in a command or job ticket, or obtained by examining the print data. The printer then prints the job, including performing necessary jam recovery functions as appropriate (step S23). While printing, the sensor device detects the number of sheets outputted to the output trays (step S23). The printer then compares the number(s) of pages to be printed (obtained in step S22) and the number(s) of sheets actually outputted (obtained from step S23) (step S24). If the numbers do not match (“N” in step S25), a warning signal is generated (step S26). If they do (“Y” in step S25), the printing ends without further actions.

Although the descriptions above use a printer as an example, the invention may also be applicable in a so-called all-in-one or multi-function device, which is a device that combines printing, scanning, and copying functions. More generally, the invention is applicable in any device that includes a printing function. The terms “printer” or “printing device” as used in this disclosure and the appended claims should be understood to broadly refer to all such devices.

Further, although FIG. 1 shows the printer 200 as being connected to a computer 100 for receiving the print job, the printer 200 may also be equipped with a memory reader such as a flash memory card reader, or a communication port such as a USB port or a FireWire port for connecting to an external memory reader, and appropriate software for reading files from an external memory such as a flash card or USB thumb drive inserted into the reader or the port. Many photo printers have this type of configuration. The user may use the user interface panel of the printer to enter print command such as the file to be printed, the number of copies, etc. Alternatively, the external memory may contain a file that specifies the print job requirements, such as which files and how many copies are to be printed.

It will be apparent to those skilled in the art that various modification and variations can be made in the printing device and related method of the present invention without departing from the spirit or scope of the invention. Thus, it is intended that the present invention cover modifications and variations that come within the scope of the appended claims and their equivalents.

What is claimed is:

1. A printing device comprising:
a print engine for forming images on sheets of recording media;
an output device for receiving sheets outputted from the print engine;
an I/O section for receiving a print job;
a control section; and
a sensor device associated with the output device and connected to the control section, the sensor device detecting sheets outputted from the print engine to the output device,
wherein the control section obtains a number of sheets to be printed for a print job, obtains from the sensor device a number of sheets actually outputted to the output device for the print job, and compares the number of sheets to be printed and the number of sheets actually outputted.

2. The printing device of claim 1, wherein the output device comprises a plurality of output trays, and wherein the sensor device comprises one or more sensors for each output tray.

3. The printing device of claim 2, wherein the control section obtains a number of sheets to be outputted to each output tray for the print job, obtains from the sensor device a number of sheets actually outputted to each output tray for the print job, and compares the number of sheets to be outputted to each output tray with the number of sheets actually outputted to each output tray.

4. The printing device of claim 1, wherein the control section further generates a warning signal if the number of sheets to be printed and the number of sheets actually outputted do not match.

5. The printing device of claim 4, further comprising a user interface section for displaying the warning signal.

6. A printing method implemented in a printer, comprising:
(a) receiving a print job;
(b) obtaining a number of sheets to be printed for the print job;
(c) generating a plurality of printed sheets based on the print job and outputting them to an output device of the printer;
(d) detecting a number of sheets actually outputted to the output device for the print job; and
(e) comparing the number of sheets to be printed and the number of sheets actually outputted to the output device.

7. The method of claim 1, wherein the output device comprises a plurality of output trays, and wherein step (d) includes detecting a number of sheets actually outputted to each output tray for the print job,

8. The method of claim 7, wherein step (b) includes obtaining a number of sheets to be outputted to each output tray for the print job, and wherein step (e) includes comparing the number of sheets to be outputted to each output tray with the number of sheets actually outputted to each output tray.

9. The method of claim 1, further comprising:
(f) generating a warning signal if in step (e) the number of sheets to be printed and the number of sheets actually outputted do not match.
